(19) United States
(12) Patent Application Publication
(10) Pub. No.: US 2015/0120389 A1
(43) Pub. Date: Apr. 30, 2015

(54) Interactive Guide Creation, Feedback Collection, And Management

(71) Applicant: BlueJay Mobile-Health, Inc., Orinda, CA (US)

(72) Inventors: Dongxiao Zhang, Orinda, CA (US); Yang Sun, Orinda, CA (US); Di Shan, Pleasanton, CA (US); Chen Peng, Pleasanton, CA (US)

(73) Assignee: BlueJay Mobile-Health, Inc.

(21) Appl. No.: 14/520,372

(22) Filed: Oct. 22, 2014

Related U.S. Application Data
(60) Provisional application No. 61/895,511, filed on Oct. 25, 2013.

(51) Int. Cl. G06Q 30/00; G06Q 30/02; G06Q 10/10

(52) U.S. Cl. CPC G06Q 30/016; G06Q 10/10; G06Q 30/0203
USPC 705/7.32; 705/304

(57) ABSTRACT

A computer implemented method and an interactive guide management system (IGMS) for creating and managing interactive guides (IGs) for multiple items with feedback collection and customer support are provided. The IGMS creates IGs based on media content specific to the items received from item provider devices and stores the IGs in a guide management database (GMD). The IGMS generates a client application that displays the IGs for each item and interface elements for executing interactive functions based on functional inputs on a customer device. The GMD transmits the IGs to the client application based on item information for display in a stepwise manner. The IGMS receives customer inputs, functional inputs, and feedback information provided by the customer device via multiple communication modes from the client application via a network for providing real time or time shifted support, dynamically updating and managing the IGs, and performing one or more interactive functions.

### CROSS REFERENCE TO RELATED APPLICATIONS

This application claims priority to and the benefit of provisional patent application No. 61/895,511 titled “Interactive Guide Creation, Feedback Collection, And Management”, filed in the United States Patent and Trademark Office on Oct. 25, 2013. The specification of the above referenced patent application is incorporated herein by reference in its entirety.

### BACKGROUND

User guides and user manuals are technical communication documents used to facilitate, for example, product installation, product use, troubleshooting problems associated with product installation and/or use, product maintenance, product upgrade, product disposal, product training, etc. A large number of products are difficult to install or need significant learning before use. Customers have to refer to user guides and user manuals to install such products. These user guides and user manuals are generally paper based. The paper based user guides and user manuals are difficult to understand and do not contain sufficient diagrams or pictures which can be quickly or correctly understood by the customers. Moreover, the paper based user guides and user manuals are static and cannot be changed or updated after the products are sold to the customers. The paper based user guides and user manuals are typically in the form of large booklets or large folding papers, which makes it difficult for the customers to search for a particular step in an installation process with ease. Furthermore, the paper based user guides and user manuals are not coupled with registration processes and do not provide an option to the customers to provide feedback on the products. There is a need for user guides that provide live and dynamic demonstrations and instructions for installation and/or use of products, thereby providing effective assistance in installation and/or use of the products. Moreover, there is a need for creating user guides that allow customers to provide feedback on a product while using the user guides.

Some manufacturers provide online user guides and user manuals which are downloadable in a portable document format (PDF) file form. However, the online user guides and user manuals are difficult to access and are not handy while customers are installing the products. Moreover, the online user guides and user manuals do not provide relevant tools to navigate to the right steps. Some manufacturers of products also upload online demonstrations and training guides on the products using video files, for example, on YouTube® of Google, Inc. However, these video files are not interactive or dynamic. The video files do not respond to customer's choices or provide feedback options. Furthermore, these video files do not evolve with the feedback, are not updated based on the collected feedback, and are not continuously managed or improved by the manufacturers. Hence, there is a need for an easily accessible, dynamic, and interactive guide that collects real time feedback from the customers and evolves with the collected feedback.

Manufacturers also provide customer support for product installation and use via customer service centers. However, customer support on product installation and use are typically performed through conventional helpdesk services via telephones. The customers are required to describe the problems and difficulties verbally to vendors to seek help. Moreover, the vendors rely on paper surveys and phone calls to collect feedback which are not effective. There is a need for dynamically and effectively providing customer support service for product installation and use along with updating and improving the customer support service based on feedback received from the customers, for ensuring efficient delivery of customer support service to the customers.

Hence, there is a long felt but unresolved need for a computer implemented method and system that creates easily accessible, dynamic, and interactive guides for multiple items from different manufacturers, service providers, etc., and manages the interactive guides with feedback collection and customer support. Moreover, there is a need for a computer implemented method and system that creates user guides that provide live and dynamic demonstrations and instructions for installation and/or use of products, thereby providing effective assistance in the installation and/or use of the products. Furthermore, there is a need for a computer implemented method and system that creates user guides that allow customers to provide feedback on a product while using the user guides. Furthermore, there is a need for a computer implemented method and system that dynamically updates and manages the interactive guides based on customer interactions and feedback acquired during product installation, product use, or product training. Furthermore, there is a need for a computer implemented method and system that enables multiple vendors to support their customers during a production installation or a training session with real time or time shifted customer service guidance, and collect customer feedback in a predetermined schedule. Furthermore, there is a need for a computer implemented method and system that dynamically and effectively provides customer support for product installation and use along with updating and improving customer support service based on feedback received from the customers, for ensuring efficient delivery of customer support service to the customers.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and the interactive guide management system disclosed herein address the above stated needs for creating easily accessible, dynamic, and interactive guides for multiple items comprising, for example, products and services from different item providers such as product manufacturers, service providers, etc., and managing the interactive guides with feedback collection and customer support. Moreover, the computer implemented method and the interactive guide management system disclosed herein create user guides that provide live and dynamic demonstrations and instructions for installation and/or use of products, thereby providing effective assistance in the installation and/or use of the products. Furthermore, the computer implemented method and the interactive guide management system disclosed herein create user guides that allow customers to provide feedback on a product while using the user guides. Furthermore, the computer implemented method and the interactive guide management system disclosed herein dynamically update and manage the interactive guides based on customer interactions and feedback acquired, for example, during item installation, item use, or item training. Furthermore, the computer implemented method and the interactive guide management system disclosed herein enable multiple item providers to support their customers during an item installation or a training session with real time or time shifted customer service guidance, and collect customer feedback in a predetermined schedule. Furthermore, the computer implemented method and the interactive guide management system disclosed herein dynamically and effectively provide customer support for product installation and use along with updating and improving customer support service based on feedback received from the customers, for ensuring efficient delivery of customer support service to the customers.

The computer implemented method disclosed herein employs the interactive guide management system comprising at least one processor configured to execute computer program instructions for creating and managing interactive guides for multiple items with feedback collection and customer support. The interactive guide management system is accessible by multiple item provider devices via a network, for example, the internet. The interactive guide management system receives media content specific to each of the items from each of the item provider devices. The interactive guide management system creates interactive guides associated with the items based on the received media content. The interactive guide management system stores the created interactive guides in a guide management database. The created interactive guides are configured to interactively display item specific data.

The interactive guide management system generates a client application specific to each of the items. The interactive guide management system is accessible by the client application on a customer device via the network. The client application is executable by at least one processor on the customer device. The client application displays the created interactive guides on the customer device and displays interface elements for executing multiple interactive functions based on functional inputs received from the customer device.

The guide management database transmits one or more of the created interactive guides specific to each item to the client application on the customer device via a network based on item information of each item received from the customer device. The client application displays one or more of the created interactive guides on the customer device in a stepwise manner via a graphical user interface on the customer device. The interactive guide management system receives one or more of customer inputs, functional inputs, and feedback information associated with the displayed interactive guides provided by the customer device via multiple communication modes, from the client application via the network, for providing real time support or time shifted support, for example, during item installation, item use, and/or item training. The interactive guide management system dynamically updates and manages the created interactive guides and performs one or more of the interactive functions based on one or more of the received customer inputs, the functional inputs, and/or the feedback information.

The computer implemented method disclosed herein employing the interactive guide management system and the client application combines an interactive guide with on the spot customer feedback and customer support service functions. In an embodiment, the computer implemented method and the interactive guide management system disclosed herein implement a single client application for multiple item providers to deliver interactive guides. Customers download the client application, input different codes for different items, and the client application displays corresponding interactive guides such as user guides, installation manuals, etc. The interactive guides allow customer interactions and multimedia demonstrations of using the items. The interactive guides allow mobile surveys and customer registrations of items, customer social networks on the same items, etc. The computer implemented method and the interactive guide management system disclosed herein benefit the customers in obtaining quick support, for example, by mobile phone calls or video calls while installing or using the items. The computer implemented method and the interactive guide management system disclosed herein also benefit the item providers, for example, product manufacturers, vendors, service providers, etc., by allowing convenient item registration and detailed customer feedback provision in a multimedia format.

In one or more various aspects, related systems include but are not limited to circuitry and/or programming for effecting the methods referenced herein; the circuitry and/or programming can be virtually any combination of hardware, software, and/or firmware configured to effect the herein-referenced methods depending upon the design choices of a system designer. Also, various structural elements may be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing carries over to the description of that method step or structure shown by that same numeral in any subsequent drawing herein.

FIG. 1 illustrates a computer implemented method for creating and managing interactive guides for multiple items with feedback collection and customer support.

FIG. 2 exemplarily illustrates a process flow diagram showing interactions between an item provider device, an interactive guide management system, and a customer device for facilitating interactive guide management, feedback collection and customer support.

FIG. 3 exemplarily illustrates a computer implemented system for creating and managing interactive guides for multiple items with feedback collection and customer support.

FIG. 4 exemplarily illustrates a software architecture employed by the interactive guide management system for creating and managing interactive guides for multiple items.

FIG. 5 exemplarily illustrates the architecture of a computer system employed by the interactive guide management system for creating and managing interactive guides for multiple items with feedback collection and customer support.

FIGS. 6A-6E exemplarily illustrate a graphical user interface provided by a client application downloadable on a customer device, where the client application displays interactive guides and interface elements for executing multiple interactive functions based on functional inputs received from a customer.

### DETAILED DESCRIPTION OF THE INVENTION

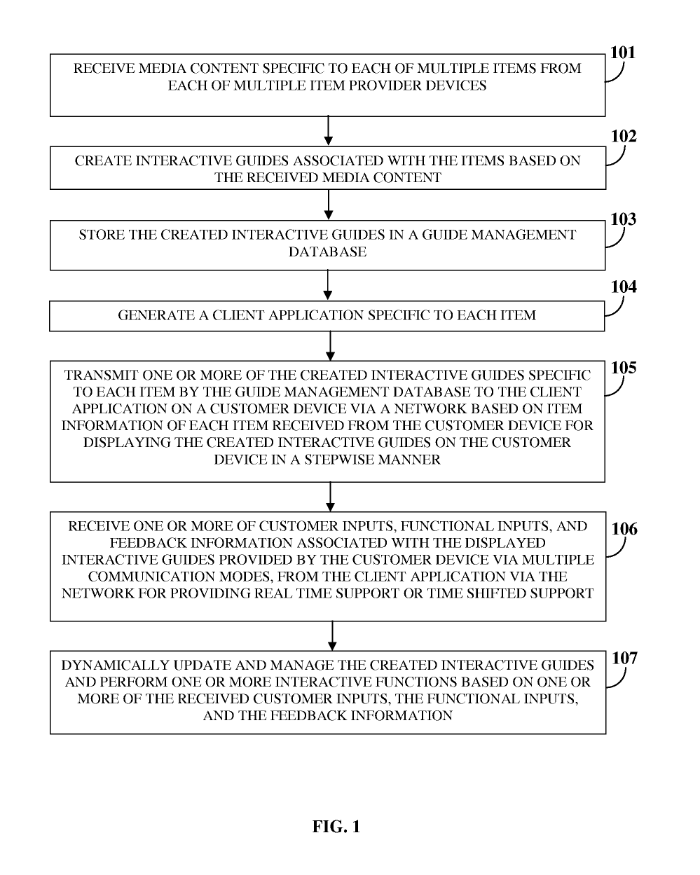

FIG. 1 illustrates a computer implemented method for creating and managing interactive guides for multiple items with feedback collection and customer support. As used herein, the term “items” refers to products such as electronic goods, sports goods, etc., and services such as training for sports activities, recreational activities, etc., which are provided to customers by item providers. Also, as used herein, “interactive guide” refers to an electronic document such as a user guide or a user manual that interacts with customers, for example, for an item installation, an item training, troubleshooting problems associated with an item installation and/or item use, an item maintenance, an item upgrade, an item disposal, etc., and provides specific instructions to the customers. In an embodiment, the interactive guide interacts with customers via queries and provides specific instructions to the customers based on the responses received from the customers. In another embodiment, the interactive guide can also receive queries from customers and provide responses with specific instructions to the customers based on the customers' queries. Also, as used herein, the term “customer” refers to a consumer or a user utilizing an item of an item provider. Also, as used herein, “item provider” refers to an entity that produces, manufactures, offers, and/or provides an item such as a product or a service. An item provider is, for example, a product manufacturer that produces or manufactures products, a service provider that provides services, a vendor, etc. The interactive guides comprise, for example, user guides or user manuals with media files comprising, for example, voice files, video files, multimedia files, and text displays that demonstrate use of the items. The computer implemented method disclosed herein enables multiple item providers, for example, product manufacturers or vendors to support customers and collect customer feedback. The computer implemented method disclosed herein provides a client application on a customer device such as a mobile device combined with online tools for item providers such as product manufacturers to collect feedback and improve the content of the interactive guides in real time or at a prescheduled time. As used herein, “customer device” refers to a handheld electronic device utilized by a customer for accessing, communicating with, and utilizing interactive guides.

The computer implemented method disclosed herein employs an interactive guide management system comprising at least one processor configured to execute computer program instructions for creating and managing interactive guides for multiple items with feedback collection and customer support. The interactive guide management system is accessible by multiple item provider devices, for example, through a broad spectrum of technologies and devices such as personal computers with access to the internet, internet enabled cellular phones, tablet computing devices, etc., via a network. As used herein, “item provider device” is an electronic device utilized by an item provider, for example, a product manufacturer or a service provider for accessing and communicating with the interactive guide management system via a network. In an embodiment, the interactive guide management system is configured as a cloud based server with video streaming capacity for transmitting, for example, video messages, video files, etc., received from item provider devices to the client application on the customer device via the network.

In an embodiment, the interactive guide management system integrates multiple social networking applications for facilitating social networking activities between customers, item providers, etc. Examples of social networking applications comprise, for example, blogs such as Slogger, LiveJournal® of Primordial Soup Ltd., Open Diary, TypePad® of The Endurance International Group, Inc., WordPress® of WordPress Foundation, Vox® and VOXopolis® of Voxopolis Inc., ExpressionEngine® of EllisLab, Inc., Xanga® of Xanga.com, Inc.; micro-blogging and presence applications comprising, for example, Twitter® of Twitter, Inc., Plurk, Tmblr.® of Tumblr, Inc., Jaiku® of Google, Inc.; social networking websites such as Bebo® of Bebo, Inc., Facebook® of Facebook, Inc., Linkedin® of Linkedin Corporation, MySpace® of MySpace Inc., Orkut® of Google, Inc., Skyrock®, Hi5® of Hi5 Networks, Inc., Ning® of Ning, Inc., Elgg and social network aggregation applications such as NutshellMail, FriendFeed® of Facebook, Inc., etc. The interactive guide management system has a social media capacity for allowing customers using the same type of items to communicate and comment on the item via the social networking applications.

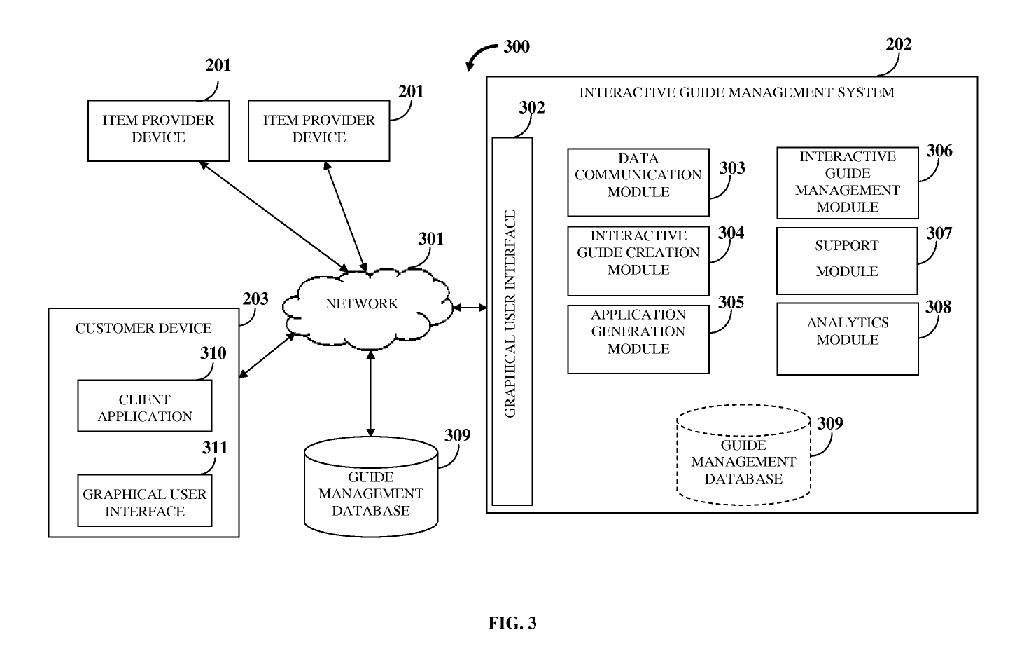

The interactive guide management system receives 101 media content specific to each of the items from each item provider device. In an embodiment, the interactive guide management system provides a graphical user interface (GUI) to allow the item providers to enter or upload the media content. The media content comprises, for example, one or more of textual content, image content such as item related drawings, audio content, video content, audiovisual content, multimedia content, digital content, etc., and any combination thereof. In an example, the interactive guide management system allows item providers to fill in instruction text and upload multimedia files containing, for example, audio content, video content, pictures, diagrams, etc., for creating the interactive guides for the items. In an embodiment, the interactive guide management system stores the received media content in a guide management database exemplarily illustrated and disclosed in the detailed description of FIG. 3. Consider an example where an item provider such as a vendor of a television (TV) system wishes to create an interactive guide for the TV system that can be used by customers who purchase the TV system from the vendor. The vendor, using an item provider device such as a personal computer, registers and logs into the interactive guide management system. The vendor, using the personal computer, uploads media content such as photos, videos, and text documents describing a process of installing the TV system, to the interactive guide management system via a network, for example, the internet. The interactive guide management system receives the photos and videos uploaded from the personal computer via the network. The interactive guide management system stores the received photos and videos in the guide management database.

The interactive guide management system creates 102 interactive guides associated with the items based on the received media content. In an embodiment, the interactive guide management system employs software programming components such as programming tools, software programs codes and algorithms developed by application developers, etc., to create the interactive guides. Consider an example where an item provider such as a vendor communicates with the interactive guide management system to create an interactive guide comprising instructions for installing a printer sold by the vendor. The vendor using a personal computer registers and logs into the interactive guide management system and uploads photos and videos describing the steps of installing the printer to the interactive guide management system via a network, for example, the internet. The interactive guide management system stores the received photos and videos in the guide management database. The interactive guide management system retrieves the photos and videos uploaded by the vendor and, in an embodiment, also retrieves media content associated with a same model of the printer provided by other vendors from the guide management database. In an embodiment, the interactive guide management system displays the acquired media content from other vendors to the vendor of the printer and prompts the vendor to provide approval for use of the acquired media content for creation of the interactive guide, via the GUI of the interactive guide management system. On receiving approval from the vendor of the printer via the GUI of the interactive guide management system, the interactive guide management system employs analytical tools to analyze the acquired photos, videos, and media content and segregate the analyzed photos, videos, and media content, such that the segregated photos, videos, and media content are configured to describe each step of installation of the printer in a correct order. The interactive guide management system creates the interactive guides based on the segregated photos, videos, and media content, thereby creating an interactive guide comprising step by step instructions for installing the printer.

The created interactive guides are configured to interactively display item specific data. In an embodiment, the interactive guide management system provides specific passcodes for each of the created interactive guides to the item providers. The interactive guide management system generates a passcode for each interactive guide created for an item provided by an item provider and transmits the generated passcode to the item provider via a network. The item provider can access the created interactive guide that is stored in the guide management database using the passcode of the interactive guide.

The interactive guide management system stores 103 the created interactive guides in the guide management database. The interactive guide management system generates 104 a client application specific to each of the items. The client application is executable by at least one processor on the customer device. The interactive guide management system generates the client application associated with each of the items based on requirements of the item providers and media content input comprising, for example, conventional user guides for the items received from item provider devices. Consider an example where an item provider such as a manufacturer of a mobile phone communicates with the interactive guide management system to create a client application that renders interactive guides for each model type of the mobile phone to customer device. The manufacturer registers and logs into the interactive guide management system via the GUI of the interactive guide management system. The manufacturer using a personal computer defines and transmits application creation parameters to the interactive guide management system via a network. The application creation parameters are configured to define interactive characteristics, specifications, and features of the client application specific to the mobile phone and each model type of the mobile phone. The application creation parameters comprise, for example, display parameters configured to define display characteristics of the client application, interactive parameters configured to define interface elements of the client application, payment processing parameters configured to define multiple payment modes that can be implemented by the client application, customer support options to facilitate communication between a customer and the manufacturer of the mobile phone, etc.

The interactive guide management system receives the application creation parameters from the manufacturer via the network. The interactive guide management system employs software programming components such as programming tools, software programs codes and algorithms developed by application developers, etc., to generate the client application for the mobile phone based on the received application creation parameters. In an embodiment, the interactive guide management system retrieves interactive guides associated with each model type of the mobile phone from the guide management database, and categorizes the retrieved interactive guides based on a model type of the mobile phone. In another embodiment, the client application retrieves interactive guides associated with each model type of the mobile phone uploaded by other item providers from the guide management database, and categorizes the retrieved interactive guides based on a model type of the mobile phone.

In an embodiment, the interactive guide management system creates an item profile for each model type of the mobile phone in the client application. In this embodiment, each item profile comprises the categorized interactive guides associated with each model type of the mobile phone. The item profile can be used to render the categorized interactive guides to the customer device via the client application. The client application is downloadable on the customer device via the network. A customer may download the client application, for example, from application stores associated with the interactive guide management system. The interactive guide management system is accessible by the client application on the customer device via the network. In an example, when a customer downloads the client application on his/her customer device such as a smartphone, the client application displays the item profile comprising the categorized interactive guides associated with each model type of the mobile phone to the customer via the GUI of the client application, thereby allowing the customer to browse or search for interactive guides associated with a desired model type of the mobile phone that can be provided by the manufacturer of the mobile phone or another item provider.

The client application displays the created interactive guides on the customer device and displays interface elements for executing multiple interactive functions based on functional inputs received from the customer device. As used herein, “interface element” refers to any software implemented switch or button, for example, a touch button or a tactile button, a screen icon type touch button, a touch pad, a form field, etc., capable of receiving an input from a customer or capturing an application of pressure from the customer. The interface elements comprise touch buttons, for example, for a one button registration with a barcode reader and global positioning system (GPS) address “auto fill” functions, a customer support service one button call with a video option, a customer feedback with photo and/or video attachment option, an item use log option, a customer satisfaction survey option with a scheduled reminder, etc. Also, as used herein, “functional inputs” refer to inputs received from a customer through a customer device, for example, via the GUI of the client application for selection of an interactive function to be executed by the client application on the customer device in communication with the interactive guide management system. For example, a customer may activate an interface element for a customer support service one button call with a video option via the GUI of the client application on the customer device to initiate a video call with customer support personnel associated with an item provider. In an embodiment, the GPS address “auto fill” function of the client application dynamically updates address information of customers who use items purchased from item providers registered with the interactive guide management system. In this embodiment, the client application transmits the address information to the interactive guide management system via the network. The interactive guide management system stores the address information of the customers in the guide management database and transmits the address information of each customer to the item provider devices via the network, for enabling the item providers to provide customer support service to each of the customers.

The interactive functions executed by the interactive guide management system and/or by the client application in communication with the interactive guide management system via the network, comprise, for example, transacting media data as a multimedia message, a voice call, and/or a video call, registering an item with code information and dynamic address information, generating a log of usage of the items, managing social networking activities associated with the items, performing search functions, managing a customer satisfaction survey with scheduled reminders, managing a payment transaction with the customer device, managing language selections received from the customer device for the created interactive guides, etc. In an embodiment, the client application provides multiple registration options for registering an item with the interactive guide management system via the customer device. The client application allows item registration through the customer device, for example, a mobile phone, with a phone number, a location via a global positioning system (GPS), a one click registration by barcode scanning of an item model, etc. For example, a customer can scan a barcode of an item or a quick response (QR) code of the item onto a registration form displayed in the GUI of the client application, and submit the registration form to the interactive guide management system using the customer device.

In an embodiment, the dynamic address information used for registering an item is the address of a customer who purchased the item. Consider an example where a customer who purchased an item wishes to use an interactive guide for the item. The customer downloads the client application from an application store associated with the interactive guide management system onto his/her customer device. The client application displays a registration form to the customer via the GUI for registering the item. The client application prompts the customer to input, for example, address information of the customer, contact information, information associated with the item such as item specifications, issues with use of the item, etc., in the registration form via the GUI of the client application. In an embodiment, the GPS address “auto fill” function of the client application dynamically updates the registration form with the address of the customer and prompts the customer to verify the dynamic address information displayed on the GUI of the client application. The customer verifies and submits the registration form via the GUI of the client application. The client application transmits the submitted registration form to the interactive guide management system via the network.

In an embodiment, the client application allows for easy customer registration with item providers. For example, when a customer registers an item with the interactive guide management system via a registration form displayed on the GUI of the client application on a customer device, the client application transmits the registration form to the interactive guide management system. The interactive guide management system transmits the registration form to an item provider device, for example, of a vendor of the item from whom the customer purchased the item. The vendor provides customer support service to the customer for the item based on the information in the registration form. The client application therefore allows the customer to register with the vendor for receiving customer support service for the item bought from the vendor.

The guide management database transmits 105 one or more of the created interactive guides specific to each item to the client application on the customer device via a network based on item information of each item received from the customer device. As used herein, “item information” refers to information associated with an item received from a customer device that can be used to retrieve an interactive guide associated with the item from the guide management database. The item information inputted by the customer using a customer device can, for example, be an item identifier such as a passcode, search keywords associated with an item, a selection of an interactive guide for an item by browsing a list of interactive guides displayed on the GUI of the client application, etc. The client application retrieves the created interactive guides from the guide management database via the network based on an item identifier, for example, a passcode received from the customer device for accessing the created interactive guides. In an embodiment, the client application retrieves the created interactive guides from the guide management database via the network based on search keywords received from a customer device for accessing the created interactive guides. In another embodiment, the client application allows a customer to browse through a list of interactive guides associated with one or more items via the GUI of the client application on the customer device. In this embodiment, the client application retrieves an interactive guide from the guide management database via a network based on a selection of the interactive guide received from the customer after the customer browses the interactive guide list displayed on the GUI of the client application.

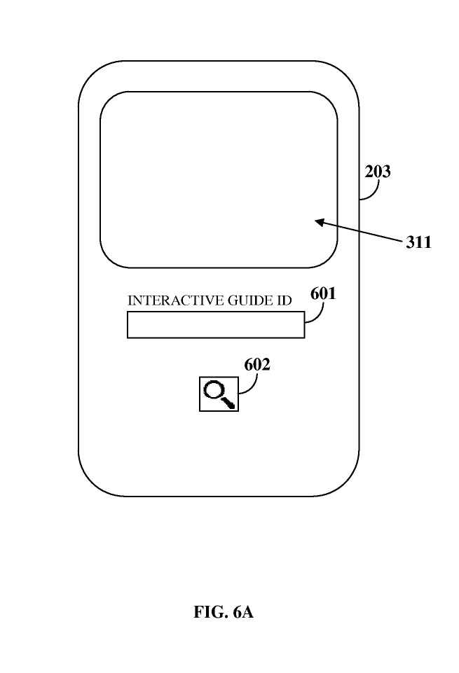

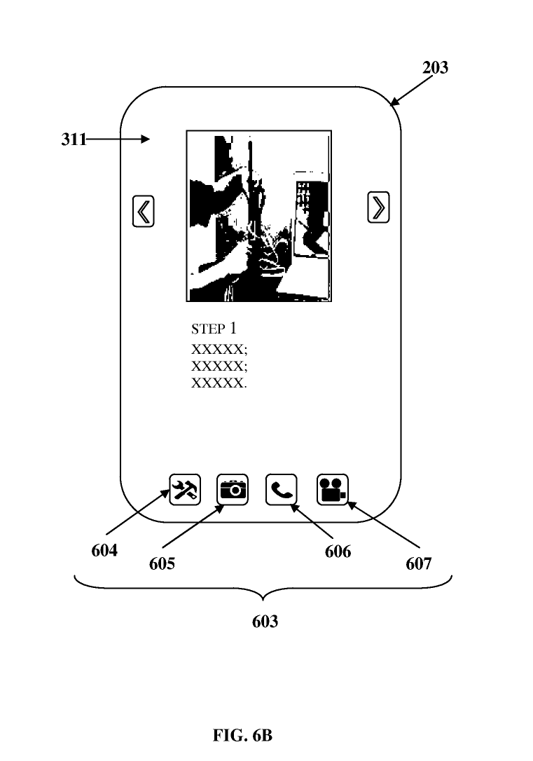

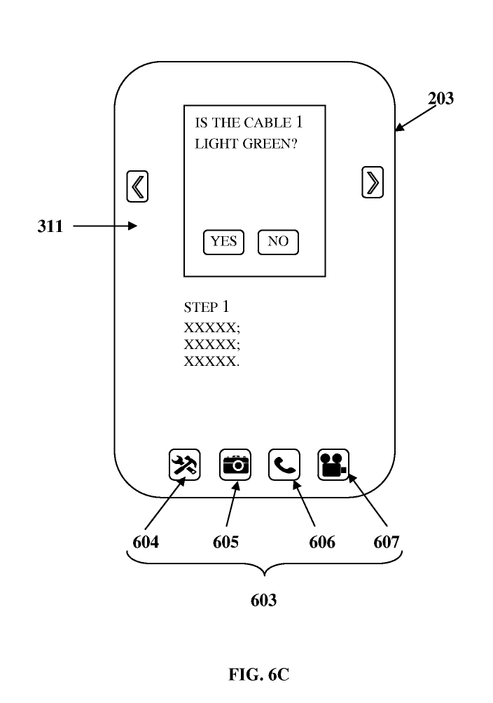

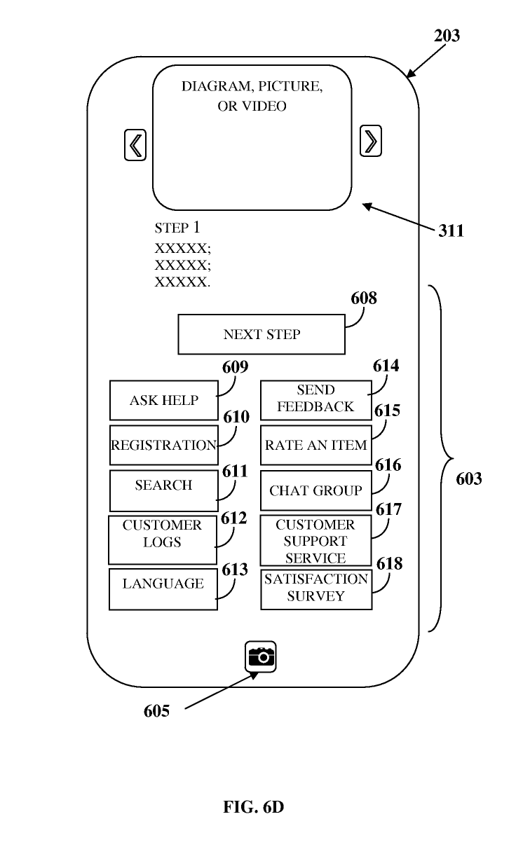

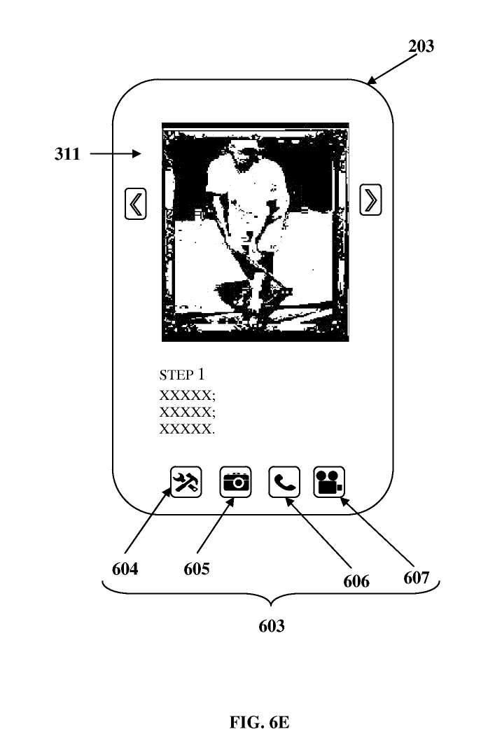

The client application allows a customer to input item specific passcodes to retrieve the created interactive guides. The client application allows the customer to input a different item passcode for retrieving an interactive guide for a different item. The client application stores the item passcodes used previously for future references. The client application precludes the need for saving volumes of paper manuals and all the updates are available in a single application. In an embodiment, the client application allows the customers to download the created interactive guides from the guide management database by inputting the item specific passcode. In another embodiment, the client application allows the customers to search for the interactive guides or search for specific steps to follow in the interactive guides using keywords as exemplarily illustrated in FIG. 6D. In another embodiment, the client application allows the customer to search or view advertisements or demonstrations of the item providers or other items of the same or different item providers. In another embodiment, the client application allows the customer to use an interactive guide from the same or different item provider and obtain customer support from the item provider.

The client application displays one or more of the created interactive guides retrieved from the guide management database on the customer device in a stepwise manner via the GUI provided by the client application. The client application displays interactive guides for multiple different items from different item providers. Each instruction page in the interactive guide focuses on a single step. The client application provides a multimedia display for displaying, for example, photos, diagrams, videos, voice, etc., in addition to a text display. In addition to textual instructions, the interactive guides also provide voice instructions to the customer. The client application allows the customer to select a language of choice to view the interactive guides. The client application is communication capable.

The customer can provide customer inputs, functional inputs, and feedback information associated with the displayed interactive guides to the interactive guide management system via the GUI of the client application on the customer device. The client application receives the customer inputs, the functional inputs, and the feedback information from the customer via the GUI of the client application and transmits the customer inputs, the functional inputs, and the feedback information to the interactive guide management system via the network. The interactive guide management system receives 106 one or more of customer inputs, functional inputs, and feedback information associated with the displayed interactive guides, provided by the customer device, via multiple communication modes from the client application via the network for providing real time support or time shifted support. As used herein, “communication mode” refers to a mode of communication between the customer device and the item provider devices and between the client application downloaded on the customer device and the interactive guide management system. The communication modes comprise communication, for example, via telephonic messages, multimedia messages, text messages, video messages, voice messages, picture messages, electronic mails (emails), voicemail, etc. The customer inputs from the customers comprise, for example, queries, responses, search information, audio requests, video requests, text requests, social media information, etc. The interactive guide management system collects the feedback information, for example, via real time feedback, surveys, and other media.

In an embodiment, the received customer inputs and the received feedback information comprise supplementary media content, for example, video attachments, image attachments, etc., specific to the items received from the customer device. The interactive guide management system facilitates communication between the customer device and the item provider devices via the network via one or more communication modes for providing real time support or time shifted support.

The interactive guide management system transmits relevant media content from the created interactive guides to the client application on the customer device via the network based on customer responses to queries transmitted by the interactive guide management system for a selective display of the relevant media content by the client application on the customer device. The client application selectively displays relevant media content from the created interactive guides on the customer device based on customer responses to queries transmitted by the interactive guide management system.

The client application relays the received inputs and feedback information to the interactive guide management system for providing real time support or time shifted support. The interactive guide management system communicates the relayed inputs and feedback information to the item providers via the network and receives responses from the item providers. The interactive guide management system, in communication with the client application via the network, provides real time audio and/or video customer support on installation and use of the items and on specific steps in the interactive guides that the customer is following, for example, based on mobile voice or video communication. The real time support aids customers who are in the process of installing or using an item and need help on the spot. Customer support centers associated with the item providers can communicate with the customer, for example, via phone or voice calls and video calls through the client application on the customer device. Customers can also provide feedback with text and photo or video supporting materials for time shifted customer support service responses. The client application allows a customer using the customer device to capture an image or a photo anytime and send the image or the photo back to the item provider to provide accurate feedback about a given step of the item installation or use in the interactive guide. The client application also allows a customer to pen or input the customer's experience and item performance in a regular customer's log or journal provided to the customer via the GUI of the client application on the customer device. The client application also activates a customer satisfaction survey at preset times set by the item providers, and allows a customer to complete and submit the surveys to the item providers and/or the interactive guide management system using the customer device via the GUI of the client application. The client application transmits the survey results and the log data for storage in the guide management database which can be accessed by the item providers via the network. In an embodiment, the client application transmits the submitted surveys to the interactive guide management system for processing via the network. The interactive guide management system stores the processed surveys in the guide management database and further transmits the processed surveys to the item providers via the network.

In an embodiment, the interactive guide management system analyzes, for example, the received customer inputs, the received functional inputs, the received feedback information, a log of usage of items received from the client application, performance of the items based on customer responses to customer satisfaction surveys received from the client application, etc. The interactive guide management system processes and summarizes survey or log data received from the client application on the customer device. The interactive guide management system stores, for example, the received customer inputs, the received functional inputs, the received feedback information, the log of usage of items received from the client application, the performance of the items based on customer responses to customer satisfaction surveys received from the client application, etc., in the guide management database. In an embodiment, the interactive guide management system executes program codes and algorithms to segregate, for example, the received customer inputs, the received functional inputs, the received feedback information, the log of usage of items received from the client application, the performance of the items based on customer responses to customer satisfaction surveys received from the client application, etc., into different data items that are further converted into different data fields. The interactive guide management system uses one or more analytical tools and/or expert inputs received via the GUI of the interactive guide management system for analyzing, for example, the received customer inputs, the received functional inputs, the received feedback information, the log of usage of items received from the client application, the performance of the items based on customer responses to customer satisfaction surveys received from the client application, etc., that are converted into the data fields.

The interactive guide management system generates analytical reports, for example, based on the analysis of one or more of the received customer inputs, the received functional inputs, the received feedback information, the log of usage of the items, the performance of the items based on customer responses to customer satisfaction surveys, etc., and renders the generated analytical reports to the item provider devices and/or to the customer device via the network. In an embodiment, the interactive guide management system uses one or more report generation tools or software to generate the analytical reports. The interactive guide management system stores the generated analytical reports in the guide management database. The stored analytical reports, survey or log data can be accessed online, for example, by item provider devices and/or customer devices via a network.

In the time shifted mode of customer support service, the client application allows customers to send queries and feedback information, for example, with text and photo or video supporting materials about a given step of installation or use to the item providers or to a customer support center. In an embodiment, the client application allows the customer using the customer device to provide feedback in built-in surveys via the GUI of the client application. The client application stores, processes, summarizes, and sends the collected information to the item providers via the network. In an embodiment, the client application sends the collected information to the item providers via the interactive guide management system. The interactive guide management system allows the item provider or the customer support center to respond to each query or a group of queries by sending text or audio or video based replies to the customer devices through the respective client applications to be accessed by the customers at their convenience.

The interactive guide management system dynamically updates and manages 107 the created interactive guides and performs one or more of the interactive functions based on one or more of the received customer inputs, the received functional inputs, and the received feedback information. In an embodiment, item providers using item provider devices can update the created interactive guides anytime on a do it yourself (DIY) web based platform provided by the interactive guide management system based on the received customer inputs, the received functional inputs, and the received feedback information. In an embodiment, the DIY web based platform is configured to operate, for example, as a paid or free software as a service (SaaS) accessible by the item provider devices via a network. In this embodiment, the DIY web based platform provides the item providers with a software application downloadable on each of the item provider devices, or a browser enabled software application to allow the item providers to update and manage the interactive guides based on the received customer inputs, the received functional inputs, and/or the received feedback information. In another embodiment, the DIY web based platform is configured to operate, for example, as a platform as a service (PaaS) accessible by the item provider devices via a network. In this embodiment, the DIY web based platform is configured, for example, in the Google App engine cloud infrastructure of Google Inc., that allows application developers using item provider devices to develop and execute software programs, algorithms, etc., that can be used to update and manage the interactive guides based on the received customer inputs, the received functional inputs, and/or the received feedback information.

Consider an example where a customer using a smartphone wishes to use an interactive guide for installing a liquid crystal display (LCD) television that the customer purchased from a showroom of an ABC vendor. The customer using a smartphone downloads a client application created by the interactive guide management system for the LCD television on the smartphone from an application store associated with the interactive guide management system via a network. The client application receives a passcode for the LCD television inputted by the customer on the GUI of the client application. The client application retrieves an interactive guide for the LCD television from the guide management database based on the passcode received from the smartphone. The client application stores the retrieved interactive guide in a local memory of the smartphone or in a cloud based database.

The client application displays the interactive guide comprising the steps for installing the LCD television to the customer via the GUI of the client application. The interactive guide displays the steps of installation of the LCD television in a stepwise manner using videos and images describing each step of the installation. The client application displays multiple interface elements on the GUI for performing multiple interactive functions that can be requested by the customer. For example, the client application provides a language settings button on the GUI to allow the customer to change the language of the interactive guide. If the customer has any queries regarding any of the steps of the installation displayed by the interactive guide or wishes to provide feedback regarding the LCD television, the customer using the smartphone selects a phone call button or a video call button for contacting a customer support service center provided by the ABC vendor. The customer can also capture images or a video comprising customer's questions and feedback using the smartphone via the GUI of the client application and send the captured images or video to the ABC vendor and/or to the interactive guide management system for processing. The client application allows the customer to register the LCD television with the ABC vendor by scanning a barcode of the LCD television using a barcode scanning functionality provided by the client application. In an embodiment, the client application automatically updates address information of the customer via a global positioning system (GPS) functionality enabled on the smartphone, for registering the LCD television.

The client application transmits the customer's questions and feedback to the interactive guide management system via the network. The interactive guide management system transmits the received images and videos with the customer's questions to the ABC vendor device via the network. The interactive guide management system receives a response comprising a supplementary video responding to the customer's questions and feedback from the ABC vendor device via the network. The interactive guide management system transmits the supplementary video to the client application on the smartphone. The client application displays the received supplementary video to the customer via the GUI. The customer follows the instructions displayed in the supplementary video, and successfully manages to install the LCD television. The client application also provides a customer log interface to the customer. The client application receives customer inputs on experience with installation and usage of the LCD television with the help of the interactive guide. The client application transmits the customer inputs to the interactive guide management system via the network. The interactive guide management system transmits the received customer inputs to the ABC vendor device via the network, to allow the ABC vendor to track performance of the LCD television.

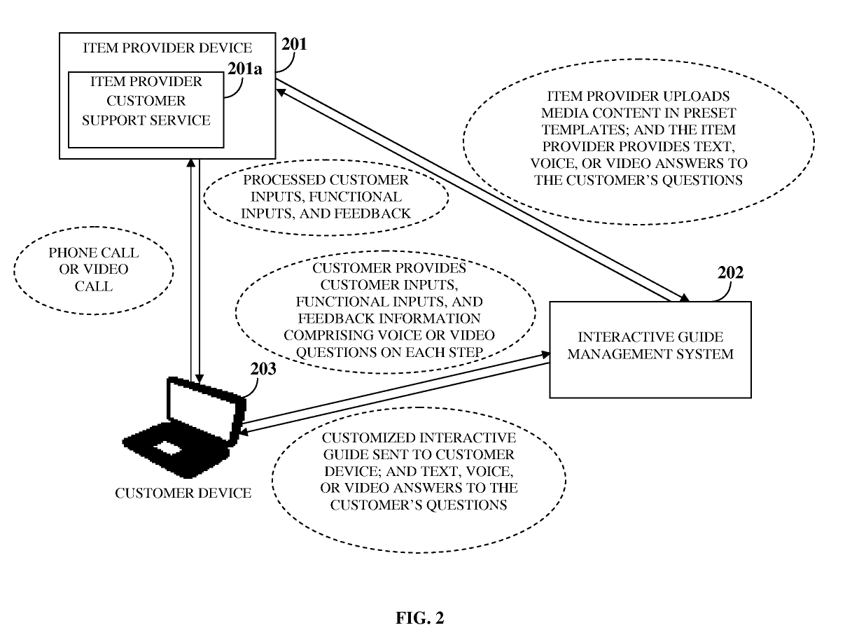

FIG. 2 exemplarily illustrates a process flow diagram showing interactions between an item provider device 201, the interactive guide management system 202, and a customer device 203 for facilitating interactive guide management, feedback collection and customer support. In an embodiment, the item provider device 201, the customer device 203, and the interactive guide management system 202 communicate with each other in a cloud computing environment. As used herein, “cloud computing environment” refers to a processing environment comprising configurable computing physical and logical resources, for example, networks, servers, storage, applications, services, etc., and data distributed over a network, for example, the internet. The cloud computing environment provides on-demand network access to a shared pool of the configurable computing physical and logical resources. In this embodiment, the interactive guide management system 202 is configured as a cloud based server implemented in the cloud computing environment. An item provider uploads media content in preset templates to the interactive guide management system 202. The interactive guide management system 202 creates interactive guides for items, for example, products based on a product manufacturer's request, and stores the created interactive guides in the guide management database. A customer requests for an interactive guide by inputting a passcode for a particular item in the client application installed on his/her customer device 203, for example, a tablet device. The interactive guide management system 202 sends the interactive guide to the client application on the customer device 203.

The client application allows the customer to download the relevant interactive guide on the customer device 203. The customer provides customer inputs and functional inputs related to the interactive guide through the graphical user interface (GUI) of the client application. The client application allows the customer to provide real time and time shifted feedback on the interactive guide being used by the customer. The customer's feedback comprises, for example, voice or video questions on each step of the interactive guide. In an embodiment, the client application transmits the customer inputs, the functional inputs, and the feedback to the interactive guide management system 202 via a network, for example, the internet. The interactive guide management system 202 processes the customer inputs, the functional inputs, and the feedback received from the client application and transmits the processed customer inputs, functional inputs, and feedback to the item provider device 201 via the network. The client application also allows the customer to take a picture or record a video message or a voice message on the customer device 203. The client application sends the picture or the recorded video message or voice message to the interactive guide management system 202 via the network. The interactive guide management system 202 transmits the picture or the recorded video message or voice message to the item provider device 201 in the time shifted mode. The item provider provides text, voice or video answers to the customer's questions and transmits the answers to the interactive guide management system 202 using the item provider device 201.

The interactive guide management system 202 updates or customizes the interactive guides based on the customer inputs, the functional inputs, and the feedback collected from the customer, and the answers provided by the item provider. The interactive guide management system 202 transmits the customized interactive guide and/or the text, voice, or video answers provided by the item provider to the client application on the customer device 203. The customer can view the customized interactive guide content along with text, voice, or video answers to the customer's questions on the customer device 203. A customer obtains real time or time shifted guidance on a specific step during item installation, use or training, based on the specific step in the interactive guide that the customer is following. In an embodiment, the client application allows the customer to interact directly with a customer support service center of the item provider that provides a customer support service 201a in a real time mode via phone calls or video calls. The real time mode is exemplified by phone and video calls. The time shifted mode is exemplified by sending text, voice, or video files to the interactive guide management system 202 that stores, processes, and sends the information to the item provider device 201 via the network and browser interface.

FIG. 3 exemplarily illustrates a computer implemented system 300 for creating and managing interactive guides for multiple items with feedback collection and customer support. The computer implemented system 300 disclosed herein comprises the interactive guide management system 202 accessible by a customer device 203 and item provider devices 201 via the network 301. In an embodiment, the interactive guide management system 202 is a cloud computing based platform implemented as a service for creating and managing interactive guides for multiple items with feedback collection and customer support. In an embodiment, the interactive guide management system 202 is developed, for example, using the Google App engine cloud infrastructure. The interactive guide management system 202 disclosed herein comprises a non-transitory computer readable storage medium and at least one processor communicatively coupled to the non-transitory computer readable storage medium. As used herein, “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The non-transitory computer readable storage medium is configured to store computer program instructions defined by modules, for example, 303, 304, 305, 306, 307, 308, etc., of the interactive guide management system 202. The processor is configured to execute the defined computer program instructions.

The interactive guide management system 202 communicates with the customer device 203 and one or more item provider devices 201 via the network 301. The customer device 203 and the item provider device 201 are electronic devices, for example, personal computers, tablet computing devices, mobile computers, mobile phones, smartphones, portable computing devices, laptops, personal digital assistants, touch centric devices, workstations, network enabled computing devices, interactive network enabled communication devices, image capture devices such as video cameras, web browsers, video recorders, audio recorders, etc., any other suitable computing equipment, and combinations of multiple pieces of computing equipment. The customer device 203 and the item provider device 201 may also be hybrid devices that combine the functionality of multiple devices. Examples of a hybrid device comprise a cellular telephone that includes media player functionality and a wireless communications capability, and a portable device that receives electronic mails (emails), supports mobile telephone calls, and supports web browsing. Computing equipment may be used to implement applications such as a web browser, a mapping application, an email application, etc. In an embodiment, the customer device 203 is a client device. In an embodiment, the item provider device 201 is implemented as one or more servers associated with one or more online services. The network 301 is, for example, the internet, an intranet, a wireless network, a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, etc., a local area network, a wide area network, an internet connection network, an infrared communication network, etc., or a network formed from any combination of these networks.

The interactive guide management system 202 comprises a data communication module 303, an interactive guide creation module 304, an application generation module 305, and an interactive guide management module 306. An item provider using the item provider device 201 accesses the interactive guide management system 202 via the network 301 to provide media content. In an embodiment, the interactive guide management system 202 further comprises a graphical user interface (GUI) 302 configured as a content input module to enable the item providers such as product manufacturers, vendors, service providers, etc., to input media content. The GUI 302 is, for example, a webpage of a website hosted by the interactive guide management system 202, an online web interface, a web based downloadable application interface, a mobile based downloadable application interface, etc. The data communication module 303 receives the media content specific to each item from each of multiple item provider devices 201. In an embodiment, the data communication module 303 receives the media content from the item provider devices 201 via the GUI 302.

The interactive guide creation module 304 creates interactive guides associated with the items based on the received media content. The computer implemented system 300 further comprises a guide management database 309 configured to store the created interactive guides and the received media content. In an embodiment, the interactive guide management system 202 further comprises an internal guide management database 309 for storing the created interactive guides. In another embodiment, the interactive guide management system 202 remotely accesses and communicates with the guide management database 309 via the network 301. The guide management database 309 is any storage area or medium that can be used for storing data and files. The guide management database 309 is, for example, a structured query language (SQL) data store or a not only SQL (NoSQL) data store such as the Microsoft® SQL Server®, the Oracle® servers, the MySQL® database of MySQL AB Company, the MongoDB® of MongoDB, Inc., the Neo4j graph database, the Cassandra database of the Apache Software Foundation, the HBase™ database of the Apache Software Foundation, etc. In an embodiment, the guide management database 309 can also be a location on a file system. In another embodiment, the guide management database 309 is configured as a cloud based database implemented in a cloud computing environment, where computing resources are delivered as a service over the network 301.

The application generation module 305 is a customer specific application generation module. The application generation module 305 generates a client application 310 specific to each of the items. The client application 310 is executable by at least one processor on the customer device 203. In an embodiment, the client application 310 is a software application downloadable on the customer device 203. In another embodiment, the client application 310 is implemented on a website hosted by the interactive guide management system 202 and accessible to the customer device 203 via the network 301. In another embodiment, the client application 310 is a mobile application. The client application 310 provides a graphical user interface (GUI) 311 for receiving customer inputs, functional inputs, feedback information, etc., from the customer. The GUI 311 is, for example, an online web interface, a web based downloadable application interface, a mobile based downloadable application interface, etc. The client application 310 displays the created interactive guides on the customer device 203 and displays interface elements for executing multiple interactive functions based on functional inputs received from the customer device 203 via the GUI 311. The guide management database 309 transmits one or more of the created interactive guides specific to each item to the client application 310 on the customer device 203 via the network 301 based on item information of each item received from the customer device 203 for displaying one or more of the created interactive guides on the customer device 203 in a stepwise manner.

In an embodiment, the data communication module 303 transmits relevant media content from the created interactive guides to the client application 310 on the customer device 203 via the network 301 based on customer responses to queries transmitted by the data communication module 303 for a selective display of the relevant media content by the client application 310 on the customer device 203. The data communication module 303 receives one or more of customer inputs, functional inputs, and feedback information associated with the displayed interactive guides provided by the customer device 203 via multiple communication modes, from the client application 310 via the network 301 for providing real time support or time shifted support. The interactive guide management system 202 further comprises a support module 307 for facilitating communication between the customer device 203 and the item provider devices 201 via the network 301 via one or more of the communication modes for providing real time support or time shifted support. In an embodiment, the support module 307 is configured to implement item provider-client management. In an embodiment, the support module 307 is configured as a provider-customer online support module implemented as a web based customer support service user interface. The interactive guide management module 306, in communication with the interactive guide creation module 304, dynamically updates and manages the created interactive guides and performs one or more of the interactive functions based on one or more of the received customer inputs, the functional inputs, and the feedback information.

The interactive guide management system 202 further comprises an analytics module 308 for analyzing one or more of the received customer inputs, the received functional inputs, the received feedback information, a log of usage of items received from the client application 310, performance of the items based on customer responses to customer satisfaction surveys received from the client application 310, etc. The analytics module 308 generates analytical reports based on the analysis and renders the generated analytical reports to the item provider devices 201 and/or the customer device 203 via the network 301. In an embodiment, the guide management database 309 in communication with the analytics module 308 stores the generated analytical reports.

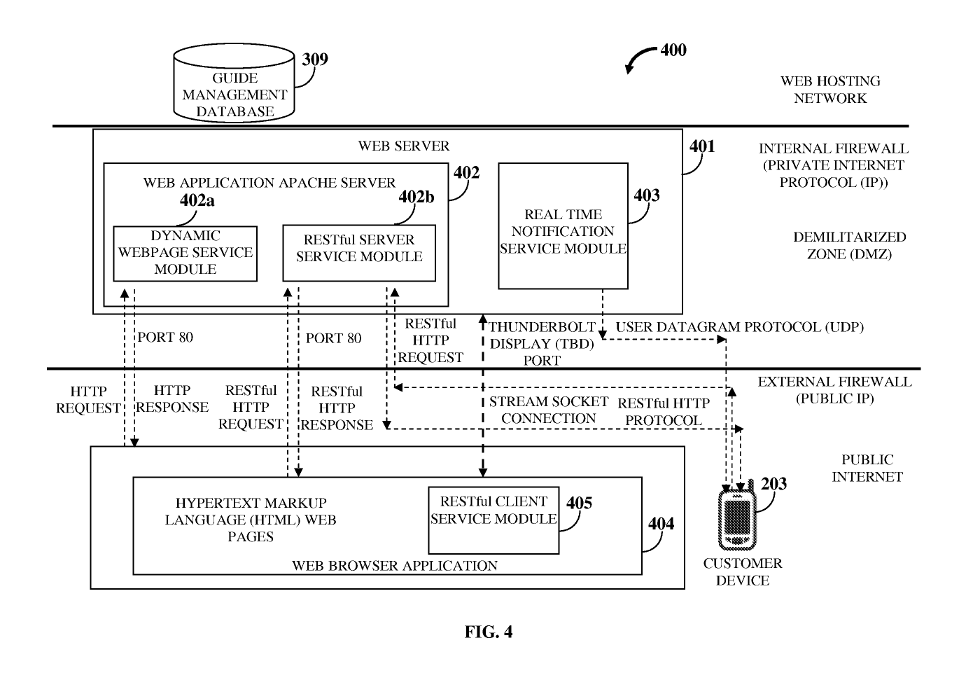

FIG. 4 exemplarily illustrates a software architecture 400 employed by the interactive guide management system 202 exemplarily illustrated in FIGS. 2-3, for creating and managing interactive guides for multiple items. FIG. 4 also shows response flows through the software architecture 400 employed by the interactive guide management system 202. A web server 401 comprising, for example, a web application Apache server 402 of Apache Software Foundation is accessible by a customer device 203, for example, a mobile device via an external firewall. The customer device 203 accessing the web application Apache server 402, for example, using public internet via the external firewall is assigned a public internet protocol (IP) address. A representational state transfer (REST) architecture is used in designing web services for the interactive guide management system 202. The guide management database 309 is implemented, for example, on a web hosting network. The web application Apache server 402 communicates with the guide management database 309, for example, for accessing interactive guides and media content via an internal firewall. The web application Apache server 402 that communicates with the guide management database 309 via the internal firewall is assigned a private IP address. The network architecture of the web server 401 is implemented in a demilitarized zone (DMZ). The customer device 203 via a web browser application 404 accesses the web server 401. The web browser application 404 comprises a RESTful client service module 405 compliant with the REST architecture of the interactive guide management system 202. In an embodiment, the client application 310, exemplarily illustrated in FIG. 3, downloaded on the customer device 203 contacts the web server 401 via the web browser application 404. The web browser application 404 displays hypertext markup language (HTML) webpages in communication with the web application Apache server 402.

The web application Apache server 402 comprises a dynamic webpage service module 402a and a RESTful server service module 402b. In an embodiment, the web browser application 404 sends a hypertext transfer protocol (HTTP) request, for example, for retrieving interactive guide content in a hypertext markup language (HTML) format to the dynamic webpage service module 402a of the web application Apache server 402 via port 80. The dynamic webpage service module 402a of the web application Apache server 402 sends an HTTP response comprising, for example, the requested interactive guide content to the web browser application 404 via port 80. In an embodiment, a RESTful client service module 405 of the web browser application 404 sends a RESTful HTTP request, for example, for retrieving interactive guide content in an HTML format to the RESTful server service module 402b of the web application Apache server 402 via port 80. The RESTful server service module 402b of the web application Apache server 402 sends a RESTful HTTP response comprising, for example, the requested interactive guide content to the RESTful client service module 405 of the web browser application 404 via port 80. The client application 310 on the customer device 203 sends a RESTful HTTP request to the RESTful server service module 402b of the web application Apache server 402, while the RESTful server service module 402b sends a RESTful HTTP response to the client application 310 on the customer device 203 via a RESTful HTTP protocol.

The web server 401 further comprises a real time notification service module 403. In an embodiment, the real time notification service module 403 sends dynamic notifications to the client application 310 on the customer device 203 via a user datagram protocol (UDP). The real time notification service module 403 transmits notifications to the client application 310 on the customer device 203, for example, for taking a customer satisfaction survey, for transmitting time shifted customer service support responses received from item provider devices 201, etc. In an embodiment, the real time notification service module 403 streams the customer service support voice or video responses to the client application 310 on the customer device 203.

In an embodiment, the web server 401 communicates with the web browser application 404 of the customer device 203 via a Thunderbolt™ display (TBD) port of Intel, Inc., using a stream socket connection. The TBD port is a peripheral device digital display interface that facilitates video communication along with audio, universal serial bus (USB), and other modes of communication between the web server 401 and the web browser application 404. The stream socket connection between the web server 401 and the web browser application 404 provides a dedicated and connection oriented communication channel for a sequenced, reliable, and lossless flow of data, along with predefined mechanisms for creating and destroying connections and for detecting errors in the data flow between the web server 401 and the web browser application 404. In an embodiment, the stream socket connection between the web server 401 and the web browser application 404 is facilitated, for example, using a transmission control protocol (TCP) or a stream control transmission protocol (SCTP).

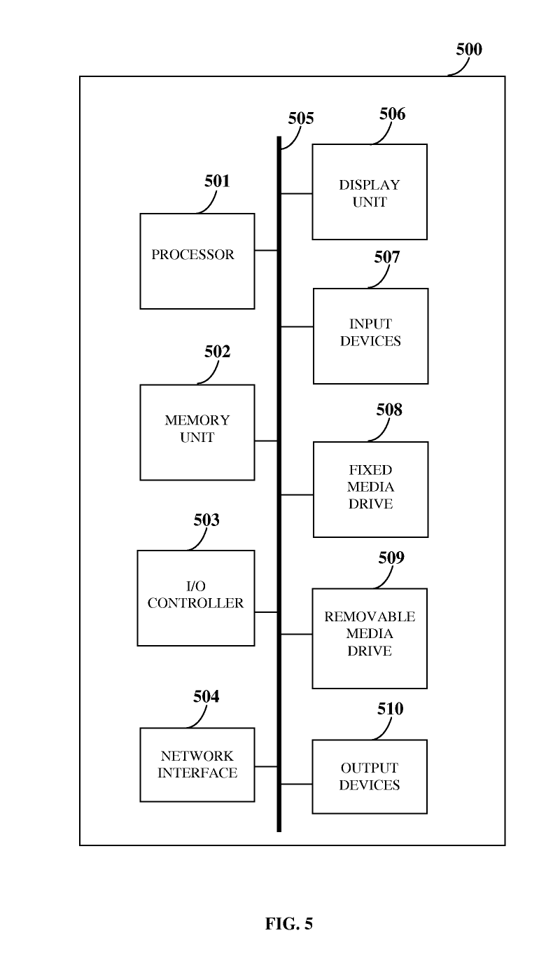

FIG. 5 exemplarily illustrates the architecture of a computer system 500 employed by the interactive guide management system 202 exemplarily illustrated in FIGS. 2-3, for creating and managing interactive guides for multiple items with feedback collection and customer support. The interactive guide management system 202 exemplarily illustrated in FIG. 3, employs the architecture of the computer system 500 exemplarily illustrated in FIG. 5. The computer system 500 is programmable using a high level computer programming language. The computer system 500 may be implemented using programmed and purposeful hardware. The interactive guide management system 202 communicates with the item provider devices 201 exemplarily illustrated in FIGS. 2-3, of each item provider registered with the interactive guide management system 202, and with the client application 310 downloaded on the customer device 203 exemplarily illustrated in FIGS. 2-4, via a network 301 exemplarily illustrated in FIG. 3, for example, a short range network or a long range network.

The computer system 500 comprises, for example, a processor 501, a non-transitory computer readable storage medium such as a memory unit 502 for storing programs and data, an input/output (I/O) controller 503, a network interface 504, a data bus 505, a display unit 506, input devices 507, a fixed media drive 508, a removable media drive 509 for receiving removable media, output devices 510, etc. The processor 501 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 501 may also be implemented as a processor set comprising, for example, a general purpose microprocessor and a math or graphics co-processor. The processor 501 is selected, for example, from the Intel® processors such as the Itanium® microprocessor or the Pentium® processors, Advanced Micro Devices)(AMD® processors such as the Athlon® processor, UltraSPARC® processors, microSPARC® processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The interactive guide management system 202 disclosed herein is not limited to a computer system 500 employing a processor 501. The computer system 500 may also employ a controller or a microcontroller. The processor 501 executes the modules, for example, 303, 304, 305, 306, 307, 308, etc., of the interactive guide management system 202.

The memory unit 502 is used for storing programs, applications, and data. For example, the data communication module 303, the interactive guide creation module 304, the application generation module 305, the interactive guide management module 306, the support module 307, the analytics module 308, etc., of the interactive guide management system 202 are stored in the memory unit 502 of the computer system 500. The memory unit 502 is, for example, a random access memory (RAM) or another type of dynamic storage device that stores information and instructions for execution by the processor 501. The memory unit 502 also stores temporary variables and other intermediate information used during execution of the instructions by the processor 501. The computer system 500 further comprises a read only memory (ROM) or another type of static storage device that stores static information and instructions for the processor 501. The I/O controller 503 controls input actions and output actions performed by the interactive guide management system 202.

The network interface 504 enables connection of the computer system 500 to the network 301. For example, the interactive guide management system 202 connects to the network 301 via the network interface 504. In an embodiment, the network interface 504 is provided as an interface card also referred to as a line card. The network interface 504 comprises, for example, one or more of an infrared (IR) interface, an interface implementing Wi-Fi® of Wi-Fi Alliance Corporation, a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The data bus 505 permits communications between the modules, for example, 302, 303, 304, 305, 306, 307, 308, 309, etc., of the interactive guide management system 202.

The display unit 506, via the graphical user interface (GUI) 302 exemplarily illustrated in FIG. 3, displays information, display interfaces, user interface elements such as text fields, checkboxes, text boxes, windows, etc., for allowing an item provider to input media content specific to each item, responses to customer inputs and feedback information received from the customer device 203, etc. The display unit 506 comprises, for example, a liquid crystal display, a plasma display, an organic light emitting diode (OLED) based display, etc. The input devices 507 are used for inputting data into the computer system 500. An administrator of the interactive guide management system 202 uses input devices 507 to provide inputs to the interactive guide management system 202 for creation of interactive guides and generation of the client application 310. For example, a software developer may enter application generation parameters for generating the client application 310 using the input devices 507. The input devices 507 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the computer system 500. The programs are loaded onto the fixed media drive 508, for example, a hard drive and into the memory unit 502 of the computer system 500 via the removable media drive 509. In an embodiment, the computer applications and programs may be loaded directly via the network 301. Computer applications and programs are executed by double clicking a related icon displayed on the display unit 506 using one of the input devices 507. The output devices 510 output the results of operations performed by the interactive guide management system 202. For example, the interactive guide management system 202 displays analytical reports generated, for example, based on an analysis of the received customer inputs, the received functional inputs, the received feedback information, a log of usage of items received from the client application 310, performance of the items based on customer responses to customer satisfaction surveys received from the client application 310, etc., to item providers using the output devices 510.

The processor 501 executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., Palm OS®, the Solaris operating system developed by Sun Microsystems, Inc., the Android operating system, the Windows Phone® operating system of Microsoft Corporation, the BlackBerry® operating system of Research in Motion Limited, the iOS operating system of Apple Inc., the Symbian® operating system of Symbian Foundation Limited, etc. The computer system 500 employs the operating system for performing multiple tasks. The operating system is responsible for management and coordination of activities and sharing of resources of the computer system 500. The operating system further manages security of the computer system 500, peripheral devices connected to the computer system 500, and network connections. The operating system employed on the computer system 500 recognizes, for example, inputs provided by users such as administrators of the interactive guide management system 202 using the input devices 507, the output display, files, and directories stored locally on the fixed media drive 508. The operating system on the computer system 500 executes different programs using the processor 501. The processor 501 and the operating system together define a computer platform for which application programs in high level programming languages are written.

The processor 501 of the computer system 500 employed by the interactive guide management system 202 retrieves instructions defined by the data communication module 303, the interactive guide creation module 304, the application generation module 305, the interactive guide management module 306, the support module 307, the analytics module 308, etc., of the interactive guide management system 202 for performing respective functions disclosed in the detailed description of FIG. 3. The processor 501 retrieves instructions for executing the modules, for example, 303, 304, 305, 306, 307, 308, etc., of the interactive guide management system 202 from the memory unit 502. A program counter determines the location of the instructions in the memory unit 502. The program counter stores a number that identifies the current position in the program of each of the modules, for example, 303, 304, 305, 306, 307, 308, etc., of the interactive guide management system 202. The instructions fetched by the processor 501 from the memory unit 502 after being processed are decoded. The instructions are stored in an instruction register in the processor 501. After processing and decoding, the processor 501 executes the instructions, thereby performing one or more processes defined by those instructions.

At the time of execution, the instructions stored in the instruction register are examined to determine the operations to be performed. The processor 501 then performs the specified operations. The operations comprise arithmetic operations and logic operations. The operating system performs multiple routines for performing a number of tasks required to assign the input devices 507, the output devices 510, and memory for execution of the modules, for example, 303, 304, 305, 306, 307, 308, etc., of the interactive guide management system 202. The tasks performed by the operating system comprise, for example, assigning memory to the modules, for example, 303, 304, 305, 306, 307, 308, etc., of the interactive guide management system 202, and to data used by the interactive guide management system 202, moving data between the memory unit 502 and disk units, and handling input/output operations. The operating system performs the tasks on request by the operations and after performing the tasks, the operating system transfers the execution control back to the processor 501. The processor 501 continues the execution to obtain one or more outputs. The outputs of the execution of the modules, for example, 303, 304, 305, 306, 307, 308, etc., of the interactive guide management system 202 are displayed to the administrator of the interactive guide management system 202 on the display unit 506.

For purposes of illustration, the detailed description refers to the interactive guide management system 202 being run locally on the computer system 500; however the scope of the computer implemented method and system 300 disclosed herein is not limited to the interactive guide management system 202 being run locally on the computer system 500 via the operating system and the processor 501, but may be extended to run remotely over the network 301 by employing a web browser and a remote server, a mobile phone, or other electronic devices. One or more portions of the computer system 500 may be distributed across one or more computer systems (not shown) coupled to the network 301.

Disclosed herein is also a computer program product comprising a non-transitory computer readable storage medium that stores computer program codes comprising instructions executable by at least one processor 501 for creating and managing interactive guides for multiple items with feedback collection and customer support. The computer program product comprises a first computer program code for receiving media content specific to each of multiple items from each of multiple item provider devices 201; a second computer program code for creating interactive guides associated with the items based on the received media content; a third computer program code for storing the created interactive guides in the guide management database 309 exemplarily illustrated in FIGS. 3-4; a fourth computer program code for generating a client application 310 specific to each item; a fifth computer program code for transmitting one or more of the created interactive guides specific to each item to the client application 310 on the customer device 203 via the network 301 based on item information of each item received from the customer device 203 for displaying one or more of the created interactive guides on the customer device 203 in a stepwise manner; a sixth computer program code for receiving one or more of customer inputs, functional inputs, and feedback information associated with the displayed interactive guides, provided by the customer device 203 via multiple communication modes, from the client application 310 via the network 301 for providing real time support or time shifted support; and a seventh program code for dynamically updating and managing the created interactive guides and performing one or more of the interactive functions based on one or more of the received customer inputs, the functional inputs, and the feedback information.

The computer program product further comprises an eighth computer program code for generating analytical reports based on an analysis of one or more of the received customer inputs, functional inputs, and feedback information, a log of usage of the items received from the client application 310, and performance of the items based on customer responses to customer satisfaction surveys received from the client application 310; a ninth computer program code for storing the generated analytical reports in the guide management database 309; and a tenth computer program code for rendering the generated analytical reports to one or more of the item provider devices 201 and the customer device 203 via the network 301. The computer program product disclosed herein further comprises one or more additional computer program codes for performing additional steps that may be required and contemplated for creating and managing interactive guides for multiple items with feedback collection and customer support. In an embodiment, a single piece of computer program code comprising computer executable instructions performs one or more steps of the computer implemented method disclosed herein for creating and managing interactive guides for multiple items with feedback collection and customer support.

The computer program codes comprising computer executable instructions are embodied on the non-transitory computer readable storage medium. The processor 501 of the computer system 500 retrieves these computer executable instructions and executes them. When the computer executable instructions are executed by the processor 501, the computer executable instructions cause the processor 501 to perform the steps of the computer implemented method for creating and managing interactive guides for multiple items with feedback collection and customer support.

FIGS. 6A-6E exemplarily illustrate a graphical user interface (GUI) 311 provided by the client application 310 exemplarily illustrated in FIG. 3, downloadable on a customer device 203, where the client application 310 displays interactive guides and interface elements 603 comprising, for example, 601, 602, 604, 605, 606, 607, 608, 609, 610, 611, 612, 613, 614, 615, 616, 617, 618, etc., exemplarily illustrated in FIGS. 6A-6E, for executing multiple interactive functions based on functional inputs received from a customer. The interactive guide management system 202 exemplarily illustrated in FIGS. 2-3, creates and stores interactive guides in the guide management database 309 exemplarily illustrated in FIGS. 3-4, based on media content received from item provider devices 201 as disclosed in the detailed description of FIG. 1. Each interactive guide provides step by step instructions for product installation, use, or training. A customer using a customer device 203 can input an item specific passcode or an interactive guide identifier in a field 601 provided on the GUI 311 and click on a search button 602 provided on the GUI 311 as exemplarily illustrated in FIG. 6A, or search for relevant interactive guides using search keywords. The client application 310 retrieves the interactive guides from the guide management database 309, for example, based on the item identifier such as the item specific passcode or a search query received from the customer and displays the interactive guides on the customer device 203. The interactive guides display, for example, video demonstrations, pictures, drawings, etc., for each step by step instruction as exemplarily illustrated in FIGS. 6B-6D, on the GUI 311 of the client application 310. The client application 310 allows a customer to interact with customer support services in a real time mode or a time shifted mode and ask an item provider such as a product manufacturer questions related to products, for example, through photo files, video files, text messages, phone calls, electronic mails, etc. The interactive guide management system 202 receives answers, for example, in text files, voice files, video files, etc., from the item provider via the network 301 exemplarily illustrated in FIG. 3, and transmits the received answers to the client application 310 downloaded on the customer device 203 or displays the received answers on the client application 310 implemented as a website. The client application 310 provides interface elements 603 with options, for example, to view a settings menu 604, a one button customer feedback option 605 such as attach and send a picture, a video file, or a voice file, a one button customer support service option such as make a phone call 606 or make a video call 607, etc., on the GUI 311 as exemplarily illustrated in FIGS. 6B-6C and FIG. 6E, for each step of the product installation or use or training. The settings menu 604 comprises, for example, options for registration, providing feedback, taking customer satisfaction surveys with scheduled reminders, selecting a language, making payments, for example, via PayPal® of PayPal, Inc., and links to a product use log.

The client application 310 executes logic or intelligent functions that display certain questions to the customers as exemplarily illustrated in FIG. 6C. The client application 310 allows customers to answer the questions via the GUI 311 of the client application 310. The client application 310 displays relevant interactive guide content and directs the customer to follow specific instructions based on the customers' answers to the questions. In an embodiment, the client application 310 provides interface elements 603 with, for example, a click option, a double click option, a click and a hold option, a tap option, a tap and a hold option, a touch option, etc., on the GUI 311. As exemplarily illustrated in FIG. 6D, the interface elements 603 comprise, for example, a “next step” button 608 to navigate to a next step of installation, use, or training, an “ask help” button 609 to ask for help, a “send feedback” button 614 to send feedback to an item provider, a “registration” button 610 to register an item, a “rate an item” button 615 to rate an item based on performance, a “search” button 611 to search for an item or an interactive guide of an item, a “customer logs” button 612 to enter feedback, for example, about an item, an interactive guide, or services of an item provider, etc., in customer logs, a “customer support service” button 617 to contact customer support service of an item provider, a “language” button 613 to change language settings of the client application 310 and/or an interactive guide, a “chat group” button 616 to access links to chat groups, a “satisfaction survey” button 618 to take customer satisfaction surveys provided by item providers, etc. The client application 310 provides a one button registration of an item via the registration button 610 along with a bar code scanning function and a global positioning system (GPS) based address auto fill function. In an embodiment, the client application 310 can also be used by customers for personalized training, for example, in sport activities or recreational activities as exemplarily illustrated in FIG. 6E.

It will be readily apparent that the various methods, algorithms, and computer programs disclosed herein may be implemented on computer readable media appropriately programmed for computing devices. As used herein, “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, JavaScript®, Fortran, Ruby, Perl®, Python®, Visual Basic®, hypertext preprocessor (PHP), Microsoft®.NET etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises one or more computer program codes for implementing the processes of various embodiments.

Where databases are described such as the guide management database 309 exemplarily illustrated in FIGS. 3-4, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method for creating and managing interactive guides for a plurality of items with feedback collection and customer support, said method employing an interactive guide management system comprising at least one processor configured to execute computer program instructions for performing said method, said method comprising:
receiving media content specific to each of said items from each of a plurality of item provider devices by said interactive guide management system;
creating said interactive guides associated with said items by said interactive guide management system based on said received media content;
storing said created interactive guides in a guide management database by said interactive guide management system;
generating a client application specific to said each of said items by said interactive guide management system, wherein said client application is executable by at least one processor on a customer device and is configured to display said created interactive guides on said customer device and display interface elements for executing a plurality of interactive functions based on functional inputs received from said customer device;
transmitting one or more of said created interactive guides specific to said each of said items by said guide management database to said client application on said customer device via a network based on item information of said each of said items received from said customer device for displaying said one or more of said created interactive guides on said customer device in a stepwise manner;
receiving one or more of customer inputs, said functional inputs, and feedback information associated with said displayed one or more of said created interactive guides, provided by said customer device via a plurality of communication modes, by said interactive guide management system from said client application via said network for providing one of real time support and time shifted support; and
dynamically updating and managing said created interactive guides and performing one or more of said interactive functions by said interactive guide management system based on one or more of said received one or more customer inputs, said functional inputs, and said feedback information.

2. The computer implemented method of claim 1, wherein said interactive functions comprise transacting media data as one or more of a multimedia message, a voice call, and a video call, registering an item with code information and dynamic address information, generating a log of usage of said items, managing social networking activities associated with said items, performing search functions, managing a customer satisfaction survey with scheduled reminders, managing a payment transaction with said customer device, and managing language selections received from said customer device for said created interactive guides.

3. The computer implemented method of claim 1, further comprising transmitting relevant said media content from said created interactive guides to said client application on said customer device via said network based on customer responses to queries transmitted by said interactive guide management system for a selective display of said relevant said media content by said client application on said customer device.

4. The computer implemented method of claim 1, wherein said received one or more customer inputs and said feedback information comprise supplementary media content specific to said items received from said customer device.

5. The computer implemented method of claim 1, further comprising facilitating communication between said customer device and said item provider devices via said network via one or more of said communication modes by said interactive guide management system for providing said one of said real time support and said time shifted support.

6. The computer implemented method of claim 1, further comprising:
generating analytical reports by said interactive guide management system based on an analysis of one or more of said received one or more customer inputs, said functional inputs, said feedback information, a log of usage of said items received from said client application, and performance of said items based on customer responses to customer satisfaction surveys received from said client application;
storing said generated analytical reports in said guide management database by said interactive guide management system; and
rendering said generated analytical reports to one or more of said item provider devices and said customer device via said network by said interactive guide management system.

7. The computer implemented method of claim 1, wherein said customer inputs comprise queries, responses, search information, audio requests, video requests, text requests, and social media information.

8. The computer implemented method of claim 1, wherein said media content comprises one or more of textual content, image content, audio content, video content, audiovisual content, multimedia content, digital content, and any combination thereof.

9. The computer implemented method of claim 1, wherein said communication modes comprise telephonic messages, multimedia messages, text messages, video messages, voice messages, picture messages, electronic mails, and voicemail.

10. An interactive guide management system for creating and managing interactive guides for a plurality of items with feedback collection and customer support, said interactive guide management system comprising:
a non-transitory computer readable storage medium configured to store computer program instructions defined by modules of said interactive guide management system;
at least one processor communicatively coupled to said non-transitory computer readable storage medium, said at least one processor configured to execute said defined computer program instructions;
a data communication module configured to receive media content specific to each of said items from each of a plurality of item provider devices;
an interactive guide creation module configured to create said interactive guides associated with said items based on said received media content;
a guide management database configured to store said created interactive guides;
an application generation module configured to generate a client application specific to said each of said items, wherein said client application is executable by at least one processor on a customer device and is configured to display said created interactive guides on said customer device and display interface elements for executing a plurality of interactive functions based on functional inputs received from said customer device;
said guide management database further configured to transmit one or more of said created interactive guides specific to said each of said items to said client application on said customer device via a network based on item information of said each of said items received from said customer device for displaying said one or more of said created interactive guides on said customer device in a stepwise manner;
said data communication module further configured to receive one or more of customer inputs, said functional inputs, and feedback information associated with said displayed one or more of said created interactive guides, provided by said customer device via a plurality of communication modes, from said client application via said network for providing one of real time support and time shifted support; and
an interactive guide management module, in communication with said interactive guide creation module, configured to dynamically update and manage said created interactive guides and perform one or more of said interactive functions based on one or more of said received one or more customer inputs, said functional inputs, and said feedback information.

11. The interactive guide management system of claim 10, wherein said interactive functions comprise transacting media data as one or more of a multimedia message, a voice call, and a video call, registering an item with code information and dynamic address information, generating a log of usage of said items, managing social networking activities associated with said items, performing search functions, managing a customer satisfaction survey with scheduled reminders, managing a payment transaction with said customer device, and managing language selections received from said customer device for said created interactive guides.

12. The interactive guide management system of claim 10, wherein said data communication module is further configured to transmit relevant said media content from said created interactive guides to said client application on said customer device via said network based on customer responses to queries transmitted by said data communication module for a selective display of said relevant said media content by said client application on said customer device.

13. The interactive guide management system of claim 10, wherein said received one or more customer inputs and said feedback information comprise supplementary media content specific to said items received from said customer device.

14. The interactive guide management system of claim 10, further comprising a support module configured to facilitate communication between said customer device and said item provider devices via said network via one or more of said communication modes for providing said one of said real time support and said time shifted support.

15. The interactive guide management system of claim 10, further comprising an analytics module configured to generate analytical reports based on an analysis of one or more of said received one or more customer inputs, said functional inputs, said feedback information, a log of usage of said items received from said client application, and performance of said items based on customer responses to customer satisfaction surveys received from said client application, and render said generated analytical reports to one or more of said item provider devices and said customer device via said network, wherein said guide management database in communication with said analytics module is further configured to store said generated analytical reports.

16. The interactive guide management system of claim 10, wherein said customer inputs comprise queries, responses, search information, audio requests, video requests, text requests, and social media information.

17. The interactive guide management system of claim 10, wherein said media content comprises one or more of textual content, image content, audio content, video content, audiovisual content, multimedia content, digital content, and any combination thereof.

18. The interactive guide management system of claim 10, wherein said communication modes comprise telephonic messages, multimedia messages, text messages, video messages, voice messages, picture messages, electronic mails, and voicemail.

19. A computer program product comprising a non-transitory computer readable storage medium, said non-transitory computer readable storage medium storing computer program codes that comprise instructions executable by at least one processor, said computer program codes comprising:
a first computer program code for receiving media content specific to each of a plurality of items from each of a plurality of item provider devices;
a second computer program code for creating interactive guides associated with said items based on said received media content;
a third computer program code for storing said created interactive guides in a guide management database;
a fourth computer program code for generating a client application specific to said each of said items, wherein said client application is executable by at least one processor on a customer device and is configured to display said created interactive guides on said customer device and display interface elements for executing a plurality of interactive functions based on functional inputs received from said customer device;
a fifth computer program code for transmitting one or more of said created interactive guides specific to said each of said items to said client application on said customer device via a network based on item information of said each of said items received from said customer device for displaying said one or more of said created interactive guides on said customer device in a stepwise manner;
a sixth computer program code for receiving one or more of customer inputs, said functional inputs, and feedback information associated with said displayed one or more of said created interactive guides, provided by said customer device via a plurality of communication modes, from said client application via said network for providing one of real time support and time shifted support; and
a seventh computer program code for dynamically updating and managing said created interactive guides and performing one or more of said interactive functions based on one or more of said received one or more customer inputs, said functional inputs, and said feedback information.

20. The computer program product of claim 19, wherein said computer program codes further comprise:
an eighth computer program code for generating analytical reports based on an analysis of one or more of said received one or more customer inputs, said functional inputs, said feedback information, a log of usage of said items received from said client application, and performance of said items based on customer responses to customer satisfaction surveys received from said client application;
a ninth computer program code for storing said generated analytical reports in said guide management database; and
a tenth computer program code for rendering said generated analytical reports to one or more of said item provider devices and said customer device via said network.
